(19) United States
(12) Patent Application Publication
(10) Pub. No.: US 2022/0234283 A1
(43) Pub. Date: Jul. 28, 2022

(54) OPTICAL SHAPING DEVICE

(71) Applicant: HONDA MOTOR CO., LTD., Minato-Ku, Tokyo (JP)

(72) Inventors: Masahito Kimori, Haga-gun, Tochigi-ken (JP); Keisuke Takahashi, Haga-gun, Tochigi-ken (JP)

(21) Appl. No.: 17/618,515

(22) PCT Filed: Apr. 9, 2020
(86) PCT No.: PCT/JP2020/015899

§ 371 Date: Dec. 13, 2021

(30) Foreign Application Priority Data
Jul. 9, 2019 (JP) 2019-127324

(51) Int. Cl. B29C 64/135; B33Y 30/00

(52) U.S. Cl. CPC B29C 64/135; B33Y 30/00

(57) ABSTRACT

This optical shaping device is provided with: a resin tank; a resin supply part that is provided to one end section of the resin tank and supplies a liquid photocurable resin to the resin tank; and a resin discharge part that is provided to the other end section of the resin tank and discharges the photocurable resin to the resin tank. While a shaped object is formed by irradiation of at least the liquid photocurable resin with laser light beam or a light flux, the resin tank causes the photocurable resin to flow from the one end section toward the other end section.

### TECHNICAL FIELD

The present invention relates to an optical shaping device that forms a shaped object by irradiating a liquid photocurable resin with light to cure the photocurable resin.

### BACKGROUND ART

Recently, stereolithography technology has been used to produce desired products.

JP 3537161 B2 discloses the following. A liquid photocurable resin mixed with metal powder (powder material) is stored in a tank (resin tank), and the photocurable resin is irradiated with light from the outside to be cured. Thus, a three dimensional shaped object is formed. Thereafter, the resin is removed from the shaped object by a resin-removal step. Finally, the shaped object from which the resin has been removed is sintered to obtain a desired metal product.

In addition, JP 4246220 B2 discloses the following. A shaping container (resin tank) for storing a photocurable resin and a pump are connected by a pipe, and the pump is driven to stir the photocurable resin in the shaping container. This prevents separation between the fine particle material (powder material) and the liquid photocurable resin.

### SUMMARY OF THE INVENTION

Incidentally, when the content of the powder material mixed in the photocurable resin is increased, the viscosity of the liquid photocurable resin increases, and the fluidity decreases. Accordingly, when optical shaping is performed in a state where the photocurable resin is stored, a stirring device or the like for uniformly mixing the powder material with the photocurable resin is necessary. In addition, in order to stir the photocurable resin having a high viscosity, the stirring device must have a high output. As a result, the optical shaping device including the stirring device becomes large.

In addition, in a case where a photocurable resin mixed with a powder material is supplied to a resin tank from the outside and the photocurable resin is poured to a light irradiation location (shaping portion), since the photocurable resin has low fluidity, it takes time until the photocurable resin reaches the shaping portion. As a result, the time taken to form the shaped object becomes longer. (Hereinafter, a photocurable resin that is a mixture with a powder material may be simply referred to as a “photocurable resin”).

Further, even when the powder material in the liquid photocurable resin is sufficiently mixed and stirred before shaping, if the photocurable resin is stored for a predetermined time or longer before shaping, the powder material present in the shaped object of the photocurable resin becomes non-uniform. As a result, the shape accuracy of a final product obtained by sintering the shaped object is reduced, and the mechanical characteristics of the final product are reduced.

The present invention has been made in consideration of such problems. It is an object of the present invention to provide an optical shaping device capable of maintaining a state where a powder material in a liquid photocurable resin is uniformly mixed without providing a stirring mechanism for stirring the photocurable resin in the optical shaping device, improving a shaping speed by preventing a decrease in fluidity even when a large amount of powder material is mixed, and allowing a final product having high shape accuracy and high mechanical characteristics to be obtained.

An aspect of the present invention relates to an optical shaping device comprising: a resin tank in which at least a bottom surface portion has a light-transmitting property and to which a photocurable resin that is in a liquid form and mixed with a powder material is supplied; a light irradiation mechanism configured to irradiate the photocurable resin with light via the bottom surface portion to cure the photocurable resin and form a shaped object; and a holding unit configured to move relative to the photocurable resin so as to be movable toward and away from the photocurable resin while holding the shaped object.

The optical shaping device further comprises: a resin supply unit provided at one end portion of the resin tank and configured to supply the photocurable resin to the resin tank; and a resin discharge unit provided at another end portion of the resin tank and configured to discharge the photocurable resin supplied to the resin tank. The resin tank is configured to cause the photocurable resin to flow from the one end portion toward the another end portion at least during formation of the shaped object.

According to the present invention, a shaped object is formed while causing a liquid photocurable resin to flow in one direction in a resin tank without storing the photocurable resin in the resin tank. This makes it unnecessary to stir the photocurable resin in the resin tank. In addition, at least during the formation of the shaped object, the photocurable resin mixed with the powder material constantly flows. Therefore, even when the powder material is contained at a high concentration in the liquid photocurable resin, it is possible to avoid a decrease in the fluidity of the liquid photocurable resin while preventing separation between the photocurable resin and the powder material. Further, the liquid photocurable resin can be supplied to the resin tank in a state where the powder material is uniformly dispersed therein.

As described above, retention and convection of the liquid photocurable resin do not occur in the resin tank. Therefore, the shaped object can be formed by irradiating the liquid photocurable resin with light in a state where the powder material is uniformly distributed therein. Accordingly, it is possible to uniformly distribute the powder material in the shaped object while improving the shaping speed. As a result, a final product having high shape accuracy and high mechanical characteristics can be obtained from the shaped object.

### BRIEF DESCRIPTION OF DRAWINGS

FIG. 1 is a schematic configuration diagram of an optical shaping device according to the present embodiment;

FIG. 2 is a cross-sectional view of a resin tank of FIG. 1;

FIG. 3 is a plan view of the resin tank of FIG. 1;

FIG. 4 is a side view illustrating an example of a specific configuration of the resin tank of FIG. 1; and

FIG. 5 is a partial side view illustrating a modified example of a light irradiation mechanism of FIG. 1.

### DESCRIPTION OF THE INVENTION

Hereinafter, a preferred embodiment of an optical shaping device according to the present invention will be described with reference to the accompanying drawings.

### 1. Configuration of Present Embodiment

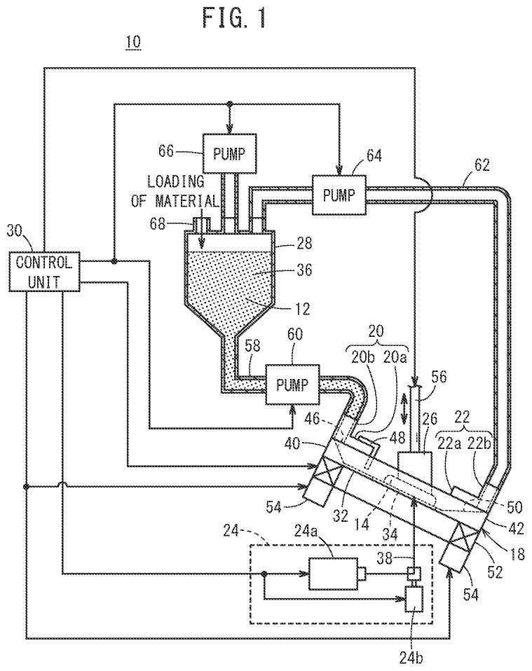

As shown in FIG. 1, an optical shaping device 10 according to the present embodiment forms a three dimensional shaped object 14 by irradiating a liquid photocurable resin 12 with light to cure the photocurable resin 12. That is, the optical shaping device 10 is a so-called 3D printer.

As shown in FIGS. 1 to 3, the optical shaping device 10 includes a resin tank 18, a resin supply unit 20, a resin discharge unit 22, a light irradiation mechanism 24, a holding unit 26, a tank 28, and a control unit 30.

The resin tank 18 is a substantially rectangular container having a relatively shallow depth (for example, a depth of about 5 mm), and the upper side thereof is open. A light-transmissive member 34 made of glass or the like is provided at a central portion of a bottom surface portion 32 of the resin tank 18. An upper surface (a surface in contact with the photocurable resin 12) of the light-transmissive member 34 is coated with a non-adhesive coating (not shown), for example, a fluorine coating, in order to facilitate peeling of the cured photocurable resin 12.

The liquid photocurable resin 12 mixed with a powder material 36 is supplied to the resin tank 18. The powder material 36 is powder of a metal material constituting a desired final product to be described later. In addition, the liquid photocurable resin 12 is formed into a paste by being mixed with the powder material 36, and is cured by light (laser light 38) emitted from the light irradiation mechanism 24 via the light-transmissive member 34. In the following description, the liquid photocurable resin 12 mixed with the powder material 36 may be referred to as “photocurable resin 12” and explained for convenience.

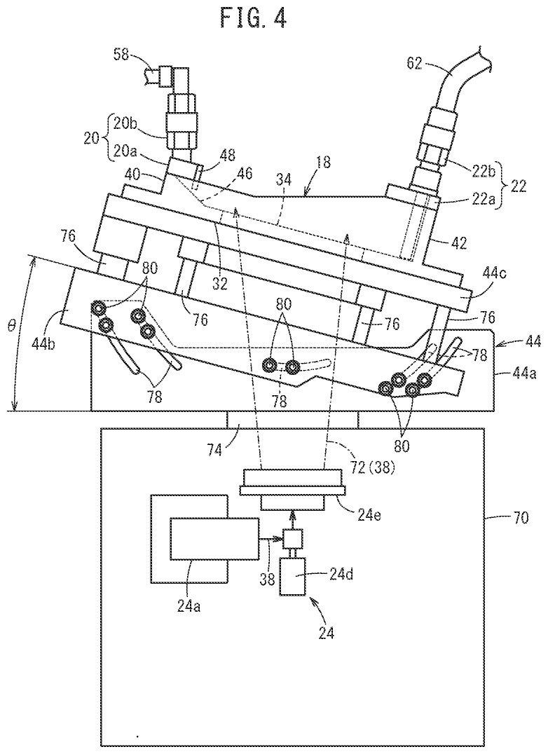

The resin supply unit 20 that supplies the photocurable resin 12 to the resin tank 18 is provided at one end portion 40 (left end portion in FIGS. 1 to 3) of the resin tank 18. On the other hand, the resin discharge unit 22 for discharging (recovering) the photocurable resin 12 in the resin tank 18 is provided at another end portion 42 (right end portion in FIGS. 1 to 3) of the resin tank 18. In the present embodiment, the resin tank 18 is entirely inclined obliquely downward from the one end portion 40 toward the other end portion 42 at an inclination angle θ (an arbitrary angle within a range of, for example, 0° to 15°) by an adjustment mechanism 44 (see FIG. 4) to be described later. Accordingly, in the resin tank 18, flow of the photocurable resin 12 is generated from the resin supply unit 20 (the one end portion 40) toward the resin discharge unit 22 (the other end portion 42) via the bottom surface portion 32.

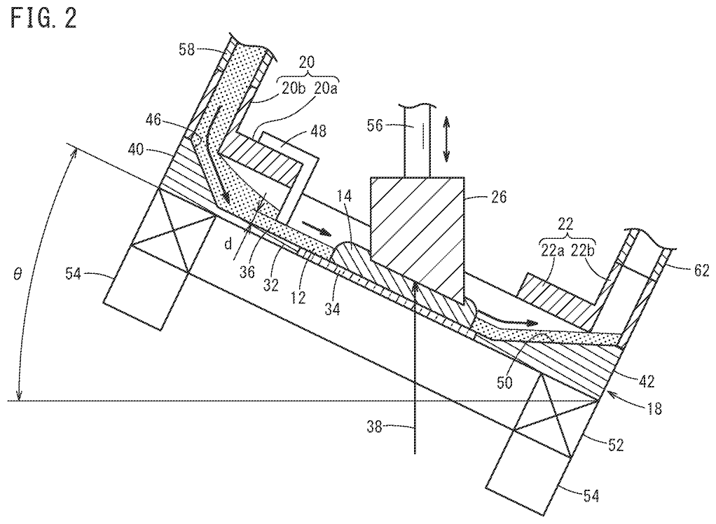

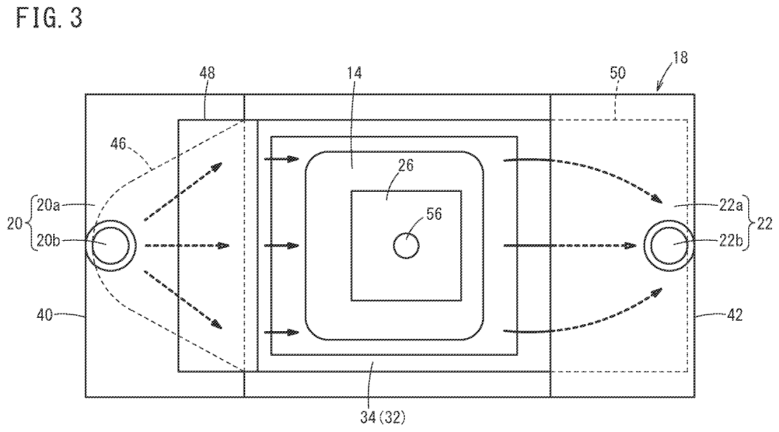

The resin supply unit 20 includes a plate 20a disposed on the one end portion 40 side of an upper surface of the resin tank 18, and a nozzle 20b extending in the vertical direction with respect to the plate 20a and communicating with the resin tank 18 through the plate 20a. As shown in FIGS. 1 to 3, the nozzle 20b is provided in the plate 20a on one end side of the resin tank 18. An inclined portion 46 is formed on one end portion 40 side of the resin tank 18. In the side view of FIG. 1 and the cross-sectional view of FIG. 2, the inclined portion 46 is inclined obliquely downward from the position of the nozzle 20b toward the bottom surface portion 32 and the light-transmissive member 34. In the plan view of FIG. 3, the inclined portion 46 expands from the position of the nozzle 20b toward the bottom surface portion 32 and the light-transmissive member 34.

A supply adjustment unit 48 for adjusting the supply amount of the photocurable resin 12 when the photocurable resin 12 is supplied from the one end portion 40 toward the other end portion 42 of the resin tank 18 is provided at a distal end portion of the plate 20a in the resin supply unit 20. The supply adjustment unit 48 is a substantially L-shaped member in the side view of FIG. 1 and the cross-sectional view of FIG. 2. In this case, a gap d having a predetermined width is formed between a distal end portion of the supply adjustment unit 48 and the bottom surface portion 32 of the resin tank 18. The gap d is set at a position corresponding to an amount necessary for forming at least one layer (for example, a thickness of 0.01 mm to 0.5 mm) of the shaped object 14 when the liquid photocurable resin 12 is caused to flow from the one end portion 40 toward the other end portion 42 of the resin tank 18.

Accordingly, the inclined portion 46, that is, the portion from the nozzle 20b to the supply adjustment unit 48, functions as a chamber that stores the photocurable resin 12 on the upstream side in the flow direction of the photocurable resin 12 in the resin tank 18. In this case, as shown in FIG. 3, the supply adjustment unit 48 side of the inclined portion 46 is set to be wider than the holding unit 26. In addition, the supply adjustment unit 48 functions as a regulation plate having the gap d (opening) that regulates the flow of the photocurable resin 12 from the chamber.

On the other hand, the resin discharge unit 22 includes a plate 22a disposed on the other end portion 42 side of the upper surface of the resin tank 18, and a nozzle 22b extending in the vertical direction with respect to the plate 22a and communicating with the resin tank 18 through the plate 22a. As shown in FIGS. 1 to 3, the nozzle 22b is provided in the plate 22a on the other end side of the resin tank 18. An inclined portion 50 is provided on the other end portion 42 side of the resin tank 18. In the side view of FIG. 1 and the cross-sectional view of FIG. 2, the inclined portion 50 is inclined obliquely upward from the light-transmissive member 34 and the bottom surface portion 32 toward the position of the nozzle 22b. In the plan view of FIG. 3, the inclined portion 50 has a substantially rectangular shape.

A heater 52 is provided below the bottom surface portion 32 of the resin tank 18. The heater 52 heats and keeps (maintains) the photocurable resin 12 in the resin tank 18 at a predetermined temperature (for example, 60° C. to 80° C.) by heating the entire resin tank 18. Further, a vibration applying unit 54 such as an ultrasonic vibrator for applying vibration to the photocurable resin 12 in the resin tank 18 is provided below the bottom surface portion 32 of the resin tank 18.

The light irradiation mechanism 24 is disposed below the resin tank 18 and includes a laser light source 24a and a scanner 24b. The laser light source 24a outputs the laser light 38 having a predetermined wavelength (for example, light having an ultraviolet wavelength) that enables the liquid photocurable resin 12 to be cured. The scanner 24b scans (irradiates), via the light-transmissive member 34, the liquid photocurable resin 12 with the laser light 38 from the laser light source 24a.

The holding unit 26 is provided above the light-transmissive member 34 in the resin tank 18. In the side view of FIG. 1 and the cross-sectional view of FIG. 2, the holding unit 26 is formed in a substantially trapezoidal shape in which a bottom surface portion is inclined obliquely downward correspondingly to the inclination angle θ. A moving unit 56, which is a rising and falling unit such as a piston, is connected to an upper end portion of the holding unit 26. When the holding unit 26 is moved up and down by the moving unit 56, the holding unit 26 can move relative to the liquid photocurable resin 12 flowing on the upper surface of the light-transmissive member 34 so as to be movable toward and away from the liquid photocurable resin 12.

Note that the holding unit 26 is in contact with the photocurable resin 12 such that the bottom surface portion thereof sinks into the flowing photocurable resin 12. Further, the holding unit 26 is formed to be relatively thick so as not to sink into the photocurable resin 12 as a whole.

As described above, the liquid photocurable resin 12 is cured by being scanned with the laser light 38 from the scanner 24b via the light-transmissive member 34. The holding unit 26 holds the cured photocurable resin 12. The shaped object 14 having a predetermined shape can be formed by moving up and down the holding unit 26 with respect to the photocurable resin 12 by the moving unit 56.

The tank 28 stores the liquid photocurable resin 12 mixed with the powder material 36. A resin supply path 58 is connected between a lower end portion of the tank 28 and the resin supply unit 20. A supply pump 60 is disposed in the middle of the resin supply path 58. On the other hand, a resin recovery path 62 is connected between an upper end portion of the tank 28 and the resin discharge unit 22. A discharge pump 64 is disposed in the middle of the resin recovery path 62. The upper end portion of the tank 28 is provided with an air pump 66 that pumps air, and an inspection hole 68 through which loading of the powder material 36 or the like and the condition inside the tank 28 are observed.

The above-described configuration is an example. Instead of the supply pump 60, the discharge pump 64, and the air pump 66, one vacuum pump may be disposed at the position of the discharge pump 64. In this case, the photocurable resin 12 in the resin discharge unit 22 is sucked by the negative pressure of the vacuum pump and returned into the tank 28, and the pressure in the tank 28 is reduced, whereby air bubbles in the photocurable resin 12 can be removed and the accuracy of optical shaping can be improved.

The control unit 30 is a computer that controls the entire optical shaping device 10, and controls driving of the light irradiation mechanism 24 (the laser light source 24a and the scanner 24b), the heater 52, the vibration applying unit 54, the moving unit 56, the supply pump 60, the discharge pump 64, and the air pump 66 by reading and executing a program stored in a storage unit (not shown).

In FIGS. 1 to 3, the configuration of the optical shaping device 10 is conceptually illustrated. FIG. 4 is a side view illustrating an example of a specific configuration around the resin tank 18 in the optical shaping device 10.

In FIG. 4, the light irradiation mechanism 24 is disposed on a mounting table 70 having a substantially rectangular shape. The light irradiation mechanism 24 includes the laser light source 24a, a bending portion 24d that bends upward the laser light 38 output in the horizontal direction from the laser light source 24a, and a projector 24e that projects upward the bent laser light 38 as a luminous flux 72. That is, in the example of FIG. 4, the scanner 24b of FIG. 1 is replaced with the bending portion 24d and the projector 24e.

The adjustment mechanism 44 capable of adjusting the inclination angle θ to an arbitrary angle is disposed on an upper surface of the mounting table 70. The adjustment mechanism 44 includes a base 44a that is supported by a support column 74 extending upward from the mounting table 70 and that extends in the horizontal direction, and an inclined plate 44b that can be inclined at an arbitrary angle with respect to the base 44a. A support plate 44c is supported by a plurality of support columns 76 extending upward from the inclined plate 44b, and the resin tank 18 is disposed on the support plate 44c.

In this case, one end portion side and the other end portion side of the base 44a protrude upward. A plurality of substantially arc-shaped angle adjustment grooves 78 are formed on one end portion side, the other end portion side, and a central portion of the base 44a. The inclined plate 44b is provided with a plurality of bolts 80 inserted through holes (not shown). The plurality of bolts 80 are also inserted into the angle adjustment grooves 78. In this case, in a state where the plurality of bolts 80 are loosened, the inclined plate 44b is rotated with respect to the base 44a along the plurality of angle adjustment grooves 78, and then the bolts 80 are tightened, whereby the inclined plate 44b can be fixed to the base 44a at a desired inclination angle θ. As described above, the resin tank 18 is supported by the inclined plate 44b via the support plate 44c and the plurality of support columns 76. Therefore, by adjusting the inclination angle of the inclined plate 44b with respect to the base 44a to the inclination angle θ, the resin tank 18 can be inclined at the inclination angle θ with respect to the horizontal direction.

FIG. 4 shows an example of the configuration of the adjustment mechanism 44. In the present embodiment, the adjustment mechanism 44 may have any configuration as long as the resin tank 18 can be inclined at a desired inclination angle θ with respect to the horizontal direction.

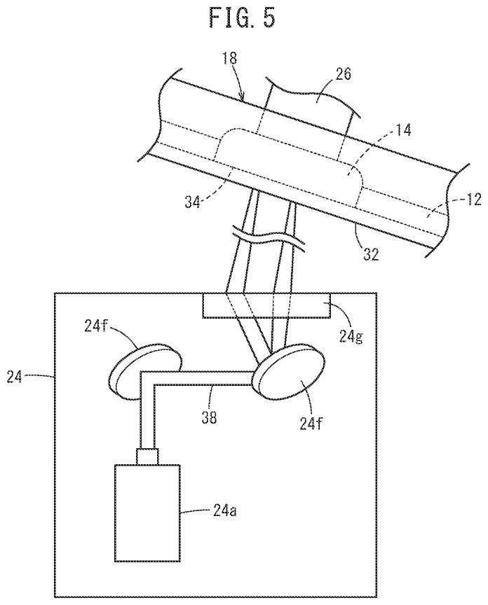

In addition, the light irradiation mechanism 24 is not limited to the above-described configuration, and may have a configuration shown in FIG. 5. Like a general 3D printer, the light irradiation mechanism 24 shown in FIG. 5 may include the laser light source 24a, one or more galvano mirrors 24f that polarize, toward the resin tank 18, the laser light 38 output from the laser light source 24a, and an F-θ lens 24g that adjusts the shape of the laser light 38.

### 2. Operation in Present Embodiment

The operation of the optical shaping device 10 configured as described above will be described with reference to FIGS. 1 to 5.

First, the resin tank 18 is inclined at a desired inclination angle θ by the adjustment mechanism 44. Thus, the resin tank 18 is inclined obliquely downward from the one end portion 40 toward the other end portion 42.

Next, in a case where the liquid photocurable resin 12 mixed with the powder material 36 is stored in the tank 28, the supply pump 60, the discharge pump 64, and the air pump 66 are driven under the control of the control unit 30. As a result, the photocurable resin 12 in the tank 28 is pressed downward by the air pumped from the air pump 66, and is pushed out from the lower end portion of the tank 28 to the resin supply path 58. Further, the photocurable resin 12 pushed out to the resin supply path 58 is supplied to the resin supply unit 20 by the supply pump 60.

The photocurable resin 12 supplied to the resin supply unit 20 is supplied to the one end portion 40 of the resin tank 18 via the nozzle 20b. As described above, since the resin tank 18 is inclined at the inclination angle θ, the supplied photocurable resin 12 flows to the other end portion 42 side of the resin tank 18 via the inclined portion 46.

The supply adjustment unit 48 is provided ahead in the flow direction of the photocurable resin 12. In this case, the gap d between the distal end portion of the supply adjustment unit 48 and the bottom surface portion 32 is set to a depth necessary for forming at least one layer of the shaped object 14. Therefore, the liquid photocurable resin 12 having a thickness corresponding to the gap d flows from the supply adjustment unit 48 to a central portion of the resin tank 18.

Then, the photocurable resin 12 passes through the upper surface of the light-transmissive member 34 and reaches the other end portion 42 of the resin tank 18. The inclined portion 50 is formed at the other end portion 42 of the resin tank 18. This inclined portion 50 is wider than the inclined portion 46 formed at the one end portion 40 of the resin tank 18. Accordingly, the photocurable resin 12 that has flowed to the other end portion 42 of the resin tank 18 is stored in the inclined portion 50.

In this case, since the discharge pump 64 is driven, the photocurable resin 12 stored in the inclined portion 50 is discharged from the inclined portion 50 to the resin recovery path 62 via the nozzle 22b of the resin discharge unit 22. The discharged photocurable resin 12 flows through the resin recovery path 62 by the discharge pump 64 and is recovered into the tank 28.

The resin tank 18 is inclined at the inclination angle θ, and the supply pump 60, the discharge pump 64 and the air pump 66 are driven. As a result, the liquid photocurable resin 12 mixed with the powder material 36 flows (circulates) through the tank 28, the resin supply path 58, the resin tank 18, the resin recovery path 62, and the tank 28 in this order without being stored, retained, or convected in the central portion of the resin tank 18.

In this embodiment, by inclining the resin tank 18 at the inclination angle θ, flow of the liquid photocurable resin 12 from the one end portion 40 toward the other end portion 42 can be generated in the resin tank 18. Therefore, in the optical shaping device 10, at least one of the supply pump 60, the discharge pump 64, or the air pump 66 may be provided.

Further, the control unit 30 may heat and keep (maintain) the photocurable resin 12 flowing in the resin tank 18 at a predetermined temperature by driving the heater 52. Furthermore, the control unit 30 may apply vibration to the photocurable resin 12 flowing in the resin tank 18 by driving the vibration applying unit 54. By applying such heating or vibration, retention of the liquid photocurable resin 12 and precipitation of the powder material 36 are suppressed, and the flow of the photocurable resin 12 can be accurately controlled.

As long as the flow of the liquid photocurable resin 12 can be controlled, the heater 52 and the vibration applying unit 54 may be provided in the middle of the above-described circulation path of the tank 28, the resin supply path 58, the resin tank 18, the resin recovery path 62, and the tank 28. Alternatively, the entire circulation path may be kept warm by the heater 52, and the photocurable resin 12 may be constantly maintained at an appropriate temperature during optical shaping.

In a state where the flow of the liquid photocurable resin 12 is ensured in this manner, the control unit 30 drives the moving unit 56 to move up and down the holding unit 26 so as to be movable toward and away from the photocurable resin 12 flowing on the upper surface of the light-transmissive member 34. In this case, the moving unit 56 moves the holding unit 26 such that the distance between a bottom surface of the holding unit 26 and the upper surface of the light-transmissive member 34 is equivalent to one layer of the shaped object 14, for example, approximately 0.01 mm to 0.5 mm. In addition, the control unit 30 drives the light irradiation mechanism 24 to irradiate the photocurable resin 12 with the laser light 38 scanned by the scanner 24b of FIG. 1, the luminous flux 72 of the laser light 38 from the projector 24e of FIG. 4, or the laser light 38 from the F-θ lens 24g of FIG. 5 via the light-transmissive member 34. As a result, the liquid photocurable resin 12 irradiated with the laser light 38 is cured.

The cured photocurable resin 12 is held by the holding unit 26. As described above, the photocurable resin 12 necessary for forming at least one layer of the shaped object 14 (shaped object 14 having a thickness corresponding to the gap d) flows on the upper surface of the light-transmissive member 34, and the holding unit 26 moves up and down. Therefore, when the photocurable resin 12 is cured in a state where the holding unit 26 is in contact with the liquid photocurable resin 12, one layer of the shaped object 14 is formed and held by the holding unit 26.

When one layer of the shaped object 14 is formed, the holding unit 26 is pulled upward by the moving unit 56. Accordingly, the shaped object 14 formed between the holding unit 26 and the light-transmissive member 34 is pulled upward in a state of being held by the holding unit 26, and is separated from the light-transmissive member 34.

Next, the moving unit 56 again moves the holding unit 26 holding one layer of the shaped object 14, downward toward the flowing liquid photocurable resin 12. Then, the holding unit 26 is positioned with a gap such that the distance between the light-transmissive member 34 and one layer of the shaped object 14 corresponds to one layer of the shaped object 14, for example, approximately 0.01 mm to 0.5 mm. At this time, the photocurable resin 12 continuously flows between one layer of the shaped object 14 held by the holding unit 26 and the light-transmissive member 34. Therefore, the photocurable resin 12 necessary for optical shaping is quickly supplied.

In this state, the liquid photocurable resin 12 is irradiated with the laser light 38 via the light-transmissive member 34. As a result, the liquid photocurable resin 12 is cured, and the shaped object 14 in which the second layer continuous with the first layer is formed is obtained.

Therefore, the three dimensional shaped object 14 formed of a plurality of layers is formed by repeatedly performing the moving operation of the holding unit 26 by the moving unit 56 with respect to the photocurable resin 12 and the irradiation of the photocurable resin 12 with the laser light 38. After the shaped object 14 having a desired shape is formed, the control unit 30 stops driving of the light irradiation mechanism 24, the supply pump 60, the discharge pump 64, and the air pump 66. Next, the control unit 30 causes the moving unit 56 to pull the holding unit 26 upward, thereby peeling the shaped object 14 held by the holding unit 26 from the resin tank 18.

In this case, the holding unit 26 is pulled upward in a state where the light-transmissive member 34 is inclined obliquely downward. As a result, the shaped object 14 can be peeled from the light-transmissive member 34 with a smaller load than when the holding unit 26 is pulled upward in a state where the light-transmissive member 34 is disposed in the horizontal direction. In addition, since the upper surface of the light-transmissive member 34 is coated with a non-adhesive coating such as a fluorine coating, the shaped object 14 can be easily peeled from the light-transmissive member 34. Thereafter, the shaped object 14 is peeled from the holding unit 26 that has been pulled up.

Next, regarding the obtained shaped object 14, the resin is removed from the shaped object 14 by a resin removal step. Finally, the shaped object 14 from which the resin has been removed is sintered, whereby a metal product having a desired shape and made of the metal material, which is the powder material 36, is obtained.

### 3. Effects of Present Embodiment

As described above, the optical shaping device 10 according to the present embodiment includes: the resin tank 18 in which at least the bottom surface portion 32 has a light-transmitting property and to which the liquid photocurable resin 12 mixed with the powder material 36 is supplied; the light irradiation mechanism 24 that irradiates the photocurable resin 12 with light (the laser light 38, the luminous flux 72) via the bottom surface portion 32 (the light-transmissive member 34) to cure the photocurable resin 12 and form the shaped object 14; and the holding unit 26 that is capable of moving relative to the photocurable resin 12 so as to be movable toward and away from the photocurable resin 12 while holding the shaped object 14.

In this case, the optical shaping device 10 further includes: the resin supply unit 20 that is provided at the one end portion 40 of the resin tank 18 and supplies the photocurable resin 12 to the resin tank 18, and the resin discharge unit 22 that is provided at the other end portion 42 of the resin tank 18 and discharges the photocurable resin 12 supplied to the resin tank 18. The resin tank 18 is configured to cause the photocurable resin 12 to flow from the one end portion 40 toward the other end portion 42 at least during formation of the shaped object 14.

According to this configuration, the shaped object 14 is formed while causing the photocurable resin 12 to flow in one direction in the resin tank 18 without storing the photocurable resin 12 in the resin tank 18. This makes it unnecessary to stir the photocurable resin 12 in the resin tank 18. In addition, at least during the formation of the shaped object 14, the photocurable resin 12 mixed with the powder material 36 constantly flows. Therefore, even when the powder material 36 is contained at a high concentration in the liquid photocurable resin 12, it is possible to avoid a decrease in the fluidity of the liquid photocurable resin 12 while preventing separation between the photocurable resin 12 and the powder material 36. In addition, the liquid photocurable resin 12 can be supplied to the resin tank 18 in a state where the powder material 36 is uniformly dispersed therein.

As described above, retention and convection of the photocurable resin 12 do not occur in the resin tank 18. Therefore, the shaped object 14 can be formed by irradiating the photocurable resin 12 with the laser light 38 or the luminous flux 72 in a state where the powder material 36 is uniformly distributed therein. Accordingly, it is possible to uniformly distribute the powder material 36 in the shaped object 14 while improving the shaping speed. As a result, a final product having high shape accuracy and high mechanical characteristics can be obtained from the shaped object 14.

The optical shaping device 10 further includes: the tank 28 for storing the photocurable resin 12; the resin supply path 58 for supplying the photocurable resin 12 from the tank 28 to the resin supply unit 20; the resin recovery path 62 for recovering the photocurable resin 12 from the resin discharge unit 22 into the tank 28; the pump 60, 64 that is provided in at least one of the resin supply path 58 or the resin recovery path 62 and pumps the photocurable resin 12; and the heater 52 for maintaining the photocurable resin 12 at a predetermined temperature. As a result, the circulation path of the photocurable resin 12 and the holding unit 26 are heated and maintained at a temperature that enables the fluidity of the photocurable resin 12 to increase. As a result, the work of forming the shaped object 14 can be smoothly performed while suppressing retention of the photocurable resin 12 and precipitation of the powder material 36 in the optical shaping device 10.

Specifically, the resin tank 18 may be inclined from the one end portion 40 toward the other end portion 42. Accordingly, it is possible to complete the work of forming (operation of shaping) a plurality of layers of the three dimensional shaped object 14 without causing the photocurable resin 12 to remain in the resin tank 18. In addition, when one layer is formed, it is possible to quickly cause the liquid photocurable resin 12 to flow between the shaped object 14 and the resin tank 18, and replenish the liquid photocurable resin 12. As a result, it is possible to shorten the cycle time until the shaping operation of the next layer.

In addition, since the resin tank 18 is inclined, when the holding unit 26 is raised after the formation of the shaped object 14, even in a case where the shaped object 14 is firmly attached to the resin tank 18, the shaped object 14 can be easily peeled from the resin tank 18 on one end side of the shaped object 14. Accordingly, it is possible to avoid occurrence of damage or the like of the shaped object 14 due to the shaped object 14 being forcibly peeled off from the resin tank 18. That is, the shaped object 14 can be peeled from the resin tank 18 without applying a large load. Therefore, it is possible to avoid damage to the resin tank 18 and the shaped object 14.

Here, the optical shaping device 10 further includes the moving unit 56 that moves the holding unit 26 in the vertical direction relative to the photocurable resin 12 when the resin tank 18 is inclined from the one end portion 40 toward the other end portion 42 at an arbitrary angle (inclination angle θ) with respect to the horizontal direction. As a result, the above-described effects can be easily obtained.

The optical shaping device 10 further includes the adjustment mechanism 44 capable of adjusting the inclination angle θ from the one end portion 40 toward the other end portion 42 of the resin tank 18 to an arbitrary angle. Thus, even if the viscosity of the photocurable resin 12 used for optical shaping changes, the photocurable resin 12 can be stably supplied to the resin tank 18 by arbitrarily changing the inclination angle θ. As a result, the shaping accuracy is improved, and optical shaping can be rapidly performed.

The optical shaping device 10 further includes the vibration applying unit 54 that applies vibration to the photocurable resin 12 in the resin tank 18. As a result, it is possible to easily control the flow of the photocurable resin 12 and increase the shaping accuracy.

The optical shaping device 10 further includes the supply adjustment unit 48 for supplying, from the one end portion 40 toward the other end portion 42, the photocurable resin 12 to a depth necessary for forming at least one layer of the shaped object 14, when the photocurable resin 12 supplied from the resin supply unit 20 to the resin tank 18 is caused to flow from the one end portion 40 toward the other end portion 42. Thus, the minimum necessary amount of the photocurable resin 12 can be caused to flow and supplied to the resin tank 18. As a result, separation between the powder material 36 and the photocurable resin 12 can be prevented. Accordingly, the liquid photocurable resin 12 always mixed with a suitable amount of the powder material 36 can be irradiated with the laser light 38 or the luminous flux 72. As a result, it is possible to easily obtain the shaped object 14 that enables a final product (metal product) to have high shape accuracy, high density, and high rigidity.

It should be noted that the present invention is not limited to the above-described embodiment, and various configurations can be adopted therein based on the description of the present specification.

What is claim is:

1. An optical shaping device comprising: a resin tank in which at least a bottom surface portion has a light-transmitting property and to which a photocurable resin that is in a liquid form and mixed with a powder material is supplied; a light irradiation mechanism configured to irradiate the photocurable resin with light via the bottom surface portion to cure the photocurable resin and form a shaped object; and a holding unit configured to move relative to the photocurable resin so as to be movable toward and away from the photocurable resin while holding the shaped object, the optical shaping device further comprising:
a resin supply unit provided at one end portion of the resin tank and configured to supply the photocurable resin to the resin tank; and
a resin discharge unit provided at another end portion of the resin tank and configured to discharge the photocurable resin supplied to the resin tank, wherein
the resin tank is configured to cause the photocurable resin to flow from the one end portion toward the another end portion at least during formation of the shaped object.

2. The optical shaping device according to claim 1, further comprising:
a tank configured to store the photocurable resin;
a resin supply path configured to supply the photocurable resin from the tank to the resin supply unit;
a resin recovery path configured to recover the photocurable resin from the resin discharge unit into the tank;
a pump provided in at least one of the resin supply path or the resin recovery path, and configured to pump the photocurable resin; and
a heater configured to maintain the photocurable resin at a predetermined temperature.

3. The optical shaping device according to claim 1, wherein
the resin tank is inclined from the one end portion toward the another end portion.

4. The optical shaping device according to claim 3, further comprising
a moving unit configured to move the holding unit in a vertical direction relative to the photocurable resin when the resin tank is inclined from the one end portion toward the another end portion at an arbitrary angle with respect to a horizontal direction.

5. The optical shaping device according to claim 3, further comprising
an adjustment mechanism configured to adjust an angle of inclination of the resin tank from the one end portion toward the another end portion to an arbitrary angle.

6. The optical shaping device according to claim 1, further comprising
a vibration applying unit configured to apply vibration to the photocurable resin in the resin tank.

7. The optical shaping device according to claim 1, further comprising
a supply adjustment unit configured to supply, from the one end portion toward the another end portion, the photocurable resin to a depth necessary for forming at least one layer of the shaped object, when the photocurable resin supplied from the resin supply unit to the resin tank is caused to flow from the one end portion toward the another end portion.
